(19) United States
(12) Patent Application Publication
(10) Pub. No.: US 2024/0168688 A1
(43) Pub. Date: May 23, 2024

(54) IMAGE FORMING APPARATUS

(71) Applicant: KYOCERA Document Solutions Inc., Osaka (JP)

(72) Inventors: Ryosuke KATO, Osaka (JP); Keisuke FUKUSHIMA, Osaka (JP); Shigenaka KANEMITSU, Osaka (JP); Yasushi TSUKAMOTO, Osaka (JP); Akihiko IKAZAKI, Osaka (JP)

(21) Appl. No.: 18/548,479

(22) PCT Filed: Feb. 22, 2022
(86) PCT No.: PCT/JP2022/007110

§ 371 Date: Aug. 30, 2023

(30) Foreign Application Priority Data
Mar. 4, 2021 (JP) 2021-034216

(51) Int. Cl. G06F 3/12

(52) U.S. Cl. CPC G06F 3/126; G06F 3/1203; G06F 3/1273

(57) ABSTRACT

A reservation management unit 24 acquires a joblog of a job that has been performed in a predetermined period, extracts as a specific job among jobs recorded in the joblog a job that the user is not a user having a predetermined relationship with the reservation user, derives a reservation timing on the basis of a time-wise distribution of the performing time point of the specific job, and performs a reservation of a print job of the reservation user to be performed at the derived reservation timing. Here, the user having a predetermined relationship with the reservation user is a user who belongs to a user group to which the reservation user belongs and the user group is a user group of users who work physically contiguously to each other.

### TECHNICAL FIELD

The present invention relates to an image forming apparatus.

### BACKGROUND ART

If there is a vacancy in a reservation time zone specified by a user, an image forming apparatus make a reservation of a job of this user in this reservation time zone (See PATENT LITERATURE #1, for example).

### CITATION LIST

### Patent Literature

PATENT LITERATURE #1: Japan Patent Application Publication No. 2014-204386.

### SUMMARY OF INVENTION

### Technical Problem

There is a request of social distancing for prevention from infection of novel coronavirus or the like. Therefore, regarding an image forming apparatus such as multi function peripheral that plural users use, while a user physically and directly uses an image forming apparatus, it is favorable that another user refrain from coming to an installation place of the image forming apparatus (for picking up a print product, for example).

Although the aforementioned image forming apparatus makes a reservation in a vacant time zone, if the reservation time zone is a time zone that relatively many users use the image forming apparatus, then when using the image forming apparatus in the reservation time zone, the reserving user may encounter another user (a user who caused to perform a print job from remote and picks up a print product, a user who reserves a job in a previous or next time zone, or the like).

The present invention has been conceived in view of the aforementioned problem. It is an object of the present invention to obtain an image forming apparatus and a reservation management program that reduce possibility that a user who caused the image forming apparatus to perform a print job encounters another user when picking up a print product.

### Solution to Problem

An image forming apparatus according to the present invention includes a reservation management unit that makes a reservation of a print job of a reservation user in accordance with a the reservation request of user. Further, the reservation management unit (a) acquires a joblog in which with regard to a job that has been performed in a predetermined period, a performing time point of the job and a user who caused to perform the job are recorded, (b) extracts as a specific job among jobs recorded in the joblog a job that the user is not a user having a predetermined relationship with the reservation user, (c) derives a reservation timing on the basis of a time-wise distribution of the performing time point of the specific job, and (d) performs a reservation of a print job of the reservation user to be performed at the derived reservation timing. Here the user having a predetermined relationship with the reservation user is a user who belongs to a user group to which the reservation user belongs and the user group is a user group of users who work physically contiguously to each other.

A reservation management program according to the present invention causes a computer to act as a reservation management unit that makes a reservation of a print job of a reservation user in an image forming apparatus in accordance with a request of the reservation user. The reservation management unit (a) acquires a joblog in which with regard to a job that has been performed in a predetermined period, a performing time point of the job and a user who caused to perform the job are recorded, (b) extracts as a specific job among jobs recorded in the joblog a job that the user is not a user having g a predetermined relationship with the reservation user, (c) derives a reservation timing on the basis of a time-wise distribution of the performing time point of the specific job, and (d) performs a reservation of a print job of the reservation user to be performed at the derived reservation timing. Here the user having a predetermined relationship with the reservation user is a user who belongs to a user group to which the reservation user belongs and the user group is a user group of users who work physically contiguously to each other.

### Advantageous Effect of Invention

By means of the present invention, obtained are an image forming system and a reservation management program that reduce possibility that a user who caused the image forming apparatus to perform a print job encounters another user when picking up a print product.

These and other objects, features and advantages of the present invention will become more apparent upon reading of the following detailed description along with the accompanied drawings.

### BRIEF DESCRIPTION OF DRAWINGS

FIG. 1 shows a diagram that indicates a configuration of an image forming system that includes an image forming apparatus according to an embodiment of the present invention;

FIG. 2 shows block diagram that indicates configurations of the image forming apparatus and a user terminal apparatus shown in FIG. 1; and

FIG. 3 shows a flowchart that explains a behavior of the image forming apparatus shown in FIGS. 1 and 2.

### DESCRIPTION OF EMBODIMENTS

Hereinafter, an embodiment according to aspects of the present invention will be explained with reference to a drawing.

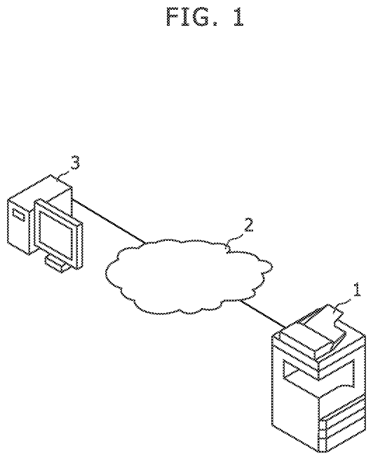

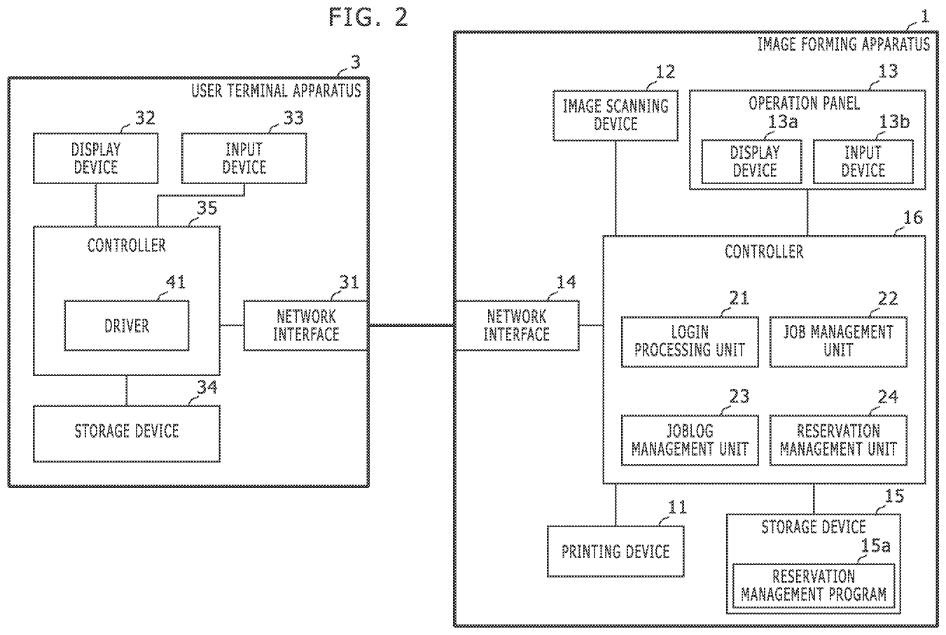

FIG. 1 shows a diagram that indicates a configuration of an image forming system that includes an image forming apparatus according to an embodiment of the present invention. FIG. 2 shows a block diagram that indicates configurations of the image forming apparatus and a user terminal apparatus shown in FIG. 1.

The system shown in FIG. 1 includes an image forming apparatus 1 (e.g. a multi function peripheral, a printer, a copier or the like) available to plural users, and a user terminal apparatus 3 (e.g. a personal computer or the like) that transmits a print job reservation request through a network 2 or the like to the image forming apparatus 1.

As shown in FIG. 2, the image forming apparatus 1 is a multi function peripheral or the like available to plural users, and includes a printing device 11, an image scanning device 12, an operation panel 13, a network interface 14, a storage device 15, and a controller 16.

The printing device 11 is an internal device that prints on a print paper sheet an image specified by the print job request (e.g. in accordance with an electrophotographic printing matter). The image scanning device 12 is an internal device that optically scans a document image of a document and generates image data of the document image.

A print job based on a print job request from the user terminal apparatus 3, the operation panel 13 of the image forming apparatus 1 or the like is performed using the printing device 11. Further, a copy job based on a copy job request the operation panel 13 of the image forming apparatus 1 or the like is performed using the image scanning device 12 and the printing device 11.

The operation panel 13 is arranged on a surface of a housing of the image forming apparatus 1, and includes a display device 13a that displays sorts of messages to a user and an input device 13b that receives a user operation. For example, a liquid crystal display is used as the display device 13a. A hard key, a touch panel and/or the like are/is used as the input device 13b.

The operation panel 13 displays an operation screen and the like using the display device 13a, to a user who is physically directly using the image forming apparatus 1, and detects a user operation by the user using the input device 13a.

The network interface 14 is a communication device that is connected to a network 2 such as a wireless LAN (Local Area Network) or a wired LAN, and performs data communication with an external device (the user terminal apparatus 3, an unshown server, or the like) connected to the network 2.

Further, the storage device 15 is a nonvolatile storage device such as a flash memory or a hard disk. In the storage device 15, a program, data and the like required for a process mentioned below have been stored.

Further, in accordance with a job request based on a user operation to the operation panel 13 or a job request received by the network interface 14 from an external device, the controller 16 performs data processing if required, and controls an internal device of the image forming apparatus 1 and thereby performs the requested job (e.g. a print job, a copy job, a facsimile transmission job, or the like). The controller 16 includes a computer that acts as sorts of processing units in accordance with a program. Here the controller 16 acts as a login processing unit 21, a job management unit 22, a joblog management unit 23, and a reservation management unit 24. In particular, the computer in the controller 16 acts as the reservation management unit 24 in accordance with a reservation management program 15a.

The login processing unit 21 displays a login screen on the operation panel 13 when the image forming apparatus 1 starts, determines user identification information (e.g. a user ID, a pair of a user ID and a password, or the like) inputted to the login screen on the operation panel 13, and performs a user authentication process for this user on the basis of the user identification information; and if the user authentication for this user succeeded, the login processing unit 21 allows the user to log-in and displays a menu screen for the user to instruct sorts of job requests, and otherwise if the user authentication for this user failed, the login processing unit 21 refuses the user to log-in and continues to display the login screen. Further, when the user performs a logout operation after logging-in, the login processing unit 21 displays the login screen again.

It should be noted that the login processing unit 21 may perform the aforementioned user authentication on the basis of user registration data (user identification information, property information and/or the like of registered users) stored in this image forming apparatus 1, or using the network interface 14, may access an external authentication server that manages user registration data and perform the aforementioned user authentication using the authentication server. This authentication server may be a resource management server such as Active Directory server.

Further, for each registered user, the user registration data includes user identification information such as user ID, and property information (a name, a user group to which the user belongs, a destination of messages, and/or the like). In this embodiment, the aforementioned property information indicates user group of users who work physically contiguously to each other, for example, a user that seats are adjacent to each other in an office, a user who work in the same room, and/or the like.

The job managing unit 22 receives a job request from the operation panel 13 or an external device such as the user terminal apparatus 3, and performs a job specified by the job request using an internal device (the printing device 11 or the like).

The joblog management unit 23 stores a joblog of a job performed by the job management unit 22 into a predetermined nonvolatile storage device.

The joblog includes a job type (print job, copy job, facsimile transmission job, scan-to-send job or the like), a job performing time point, a user (user ID or the like) who performed the job, and the like every one job.

The nonvolatile storage device in which the joblog is stored may be the storage device 15 or may be a server in the network 2.

The reservation management unit 24 makes a reservation of a print job of a reservation user (a user who wants to make a reservation) correspondingly to a reservation request of the print job by the reservation user. Specifically, the reservation management unit 24 registers a reservation record (a reservation timing at which the print job should be performed, print data, and a user ID of the reservation user) of this print job into reservation data, and when the reservation timing comes, automatically outputs a print job request of the print job to the job management unit 22, and causes the job management unit 22 to perform the print job. This reservation data is stored in a predetermined nonvolatile storage device such as the storage device 15.

Further, when finishing making the reservation, the reservation management unit 24 transmits reservation result information (reservation timing and the like) to the reservation user (here, to the user terminal apparatus 3 that the reservation user operates).

Specifically, the reservation management unit 24 (a) acquires a joblog in which with regard to a job that has been performed in a predetermined period (a period longer than a predetermined unit period mentioned below), a performing time point of the job and a user who caused to perform the job are recorded, (b) extracts as a specific job among jobs recorded in the joblog a job that the user is not a user having a predetermined relationship with the reservation user, (c) derives a reservation timing (a time point or a time zone at which the print job should be performed) in a predetermined unit period (e.g. one date, one week, one month, or the like) on the basis of a time-wise distribution of the performing time point of the specific job, and (d) performs a reservation of a print job of the reservation user to be performed at the derived reservation timing.

Here, a “user having a predetermined relationship with the reservation user” is a user who belongs to a user group to which the reservation user belongs and the user group is a user group of users who work physically contiguously to each other. A user group that each user belongs to is set as property information in the user registration data, and is determined by referring to the user registration data in the image forming apparatus 1 or in the aforementioned server.

More specifically, on the basis of the aforementioned time-wise distribution of the performing time point of the specific job, the reservation management unit 24 makes a reservation of the print job of the reservation user in a time zone of a lowest performing frequency of the aforementioned specific job among time zones of a predetermined time length obtained by dividing the unit period (for example, 1-hour time zones in the predetermined unit period such as one date or one week). Thus, the reservation timing is set in the time zone of the lowest performing frequency of the aforementioned specific job. Consequently, reduced is possibility that when the reservation user comes to the image forming apparatus 1 to pick up a print product obtained by the print job, the reservation user encounters another user other than users who work physically contiguously to each other.

As mentioned, the reservation management unit 24 derives the reservation timing regardless of a job performing frequency of the aforementioned “user having a predetermined relationship”. Specifically, The “user having a predetermined relationship” is a user who works physically contiguously to the reservation user (for example, a user whose seat is adjacent to a seat of the reservation user in an office); and such a user works with the reservation user works without keeping social distancing on a daily basis, and it is unnecessary to keep social distancing only around the image forming apparatus 1, and therefore, a job of such a user is excluded from the specific job.

The reservation management unit 24 may refer to the reservation data and thereby determine an unperformed job that is reserved by another user, and if this other user of the unperformed job is not a “user having a predetermined relationship”, then the reservation management unit 24 may include the unperformed job into the specific job and may derive the reservation timing on the basis of the time-wise distribution of the performing time point of the specific job. Further, a job of this reservation user is also excluded from the specific job.

Meanwhile, as shown in FIG. 2, the user terminal apparatus 3 includes a network interface 31, a display device 32, an input device 33, a storage device 34, a controller 35, and the like.

The network interface 31 is a network interface for a wireless LAN, a wired LAN or the like.

The display device 32 is an internal device such as a liquid crystal display, that displays an operation screen and the like for a user. The input device 33 is an internal device such as a touch panel or a key board, that detects a user operation. The display device 32 and the input device 33 may be external devices connected to the user terminal apparatus 3.

The storage device 34 is a nonvolatile storage device such as a flash memory and stores a program and data.

The controller 35 controls an internal device in the user terminal apparatus 3 and performs sorts of data processes. The controller 35 includes a computer and executes sorts of programs using the computer, and thereby acts as sorts of processing units. Here the controller 35 acts as a driver 41 for the image forming apparatus 1.

The driver 41 determines a print setting and an image to be printed (i.e. image data) in accordance with a user operation to the input device 33, generates a reservation request of a print job that specifies the print setting and the image to be printed, and transmits the reservation request using the network interface 31 to the image forming apparatus 1.

The driver 41 receives from the image forming apparatus 1 using the network interface 31 a response message that indicates reservation result information (reservation timing and the like) corresponding to the reservation request of the print job in the image forming apparatus 1, and displays the response message on the display device 32.

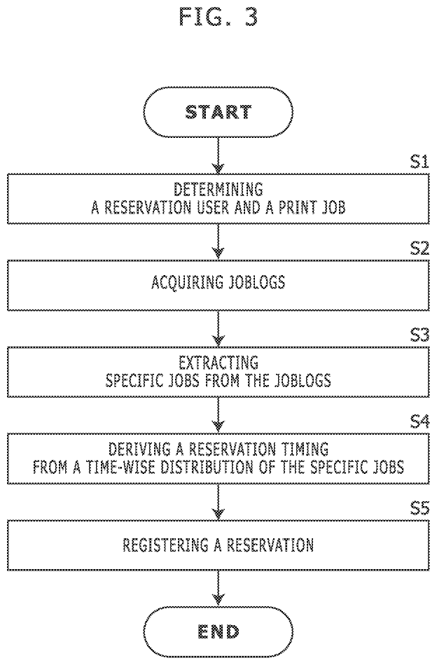

The following part explains a behavior of the aforementioned image forming apparatus 1. FIG. 3 shows a flowchart that explains a behavior of the image forming apparatus shown in FIGS. 1 and 2.

In the image forming apparatus 1, the job management unit 22 performs a job requested by a user, and the joblog management unit 23 generates a joblog of the performed job and stores the joblog into a predetermined storage device (the storage device 15 or the like).

Further, in the image forming apparatus 1, upon receiving a reservation request of a print job, the reservation management unit 24 determines a reservation user (a user ID of a user who transmits the reservation request) and a print job (print setting and print image data) that are indicated by the reservation request (in Step S1), and acquires joblogs of a predetermined period from the predetermined storage device (in Step S2).

Subsequently, the reservation management unit 24 refers to the user registration data in the storage device 15 or an external server, determines a user having a predetermined relationship with the reservation user (i.e. a user who belongs to a user group that the reservation user belongs to) on the basis of the user reservation data, and from the joblogs, extracts as a specific job a job of a user other than the user having the predetermined relationship (in Step S3).

Subsequently, the reservation management unit 24 determines performing time points of the specific jobs on the basis of the joblogs, derives a reservation timing of the print job of the reservation request on the basis of a time-wise distribution of the specific jobs based on the determined performing time points of the specific jobs (in Step S4), and registers as a reservation the reservation timing and the print job into reservation data (in Step S5). Upon finishing the reservation to the reservation data, the reservation management unit 24 transmits a response message that indicates reservation result information (reservation timing and the like) to a sender of the reservation request (here, the reservation user of the user terminal apparatus 3).

Afterward, when the reservation timing comes, the reservation management unit 24 outputs a print job request of the reserved print job to the job management unit 22, and causes the job management unit 22 to perform this print job. At that time, the reservation management unit 24 may determine a destination corresponding to a user ID of the reservation user on the basis of the aforementioned user registration data, and may transmit as an email or the like to the destination a message that the print job is performed.

As mentioned, in the aforementioned embodiment, the reservation management unit 24 (a) acquires a joblog in which with regard to a job that has been performed in a predetermined period, a performing time point of the job and a user who caused to perform the job are recorded, (b) extracts as a specific job among jobs recorded in the joblog a job that the user is not a user having a predetermined relationship with the reservation user, (c) derives a reservation timing on the basis of a time-wise distribution of the performing time point of the specific job, and (d) performs a reservation of a print job of the reservation user to be performed at the derived reservation timing. Further, the aforementioned user having a predetermined relationship with the reservation user is a user who belongs to a user group to which the reservation user belongs and the user group is a user group of users who work physically contiguously to each other.

Consequently, a job is reserved so as to refrain from a time zone with a high possibility that a user other than a user who physically contiguously works is around the image forming apparatus 1, and therefore, reduced is possibility that when a user who causes the image forming apparatus 1 to perform a print job, comes to the image forming apparatus 1 to pick up a print product, and thereat encounters other users other than users for which social distancing should be kept.

Further, it should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, the reservation management unit 24 is installed in the image forming apparatus 1, but the reservation management unit 24 may be installed in another apparatus (the user terminal apparatus 3, an external server, or the like). In such a case, the joblog may be transmitted from the image forming apparatus 1 to this other apparatus and stored in this other apparatus, or may be stored in the image forming apparatus 1 and transmitted from the image forming apparatus 1 to this other apparatus. Further, in such a case, the reservation request is transmitted from an apparatus that the user operates (the user terminal apparatus 1 or the image forming apparatus 1) to this other apparatus, and the print job request at a time that the reservation timing comes is transmitted from this other apparatus to the image forming apparatus 1.

Further, in the aforementioned embodiment, the reservation management program 15a may be stored in a non-transitory computer readable recording medium, and installed from this recording medium to the image forming apparatus 1 (or the aforementioned other apparatus).

Furthermore, in the aforementioned embodiment, a job of a job type that a user does not need to be physically close to the image forming apparatus 1 (for example, a facsimile transmission job for which a facsimile transmission image is supplied from the user terminal apparatus 3) may be excluded from the aforementioned specific job.

### INDUSTRIAL APPLICABILITY

For example, the present invention is applicable to an image forming apparatus.

1. An image forming apparatus, comprising:
a reservation management unit that makes a reservation of a print job of a reservation user in accordance with a request of the reservation user;
wherein the reservation management unit (a) acquires a joblog in which with regard to a job that has been performed in a predetermined period, a performing time point of the job and a user who caused to perform the job are recorded, (b) extracts as a specific job among jobs recorded in the joblog a job that the user is not a user having a predetermined relationship with the reservation user, (c) derives a reservation timing on the basis of a time-wise distribution of the performing time point of the specific job, and (d) performs a reservation of a print job of the reservation user to be performed at the derived reservation timing; and
the user having a predetermined relationship with the reservation user is a user who belongs to a user group to which the reservation user belongs and the user group is a user group of users who work physically contiguously to each other.

2. The image forming apparatus according to claim 1, wherein on the basis of the time-wise distribution of the performing time point of the specific job, the reservation management unit makes a reservation of the print job of the reservation user in a time zone of a lowest performing frequency of the specific job among time zones of a predetermined time length obtained by dividing the period.

3. The image forming apparatus according to claim 1, wherein the reservation management unit derives the reservation timing regardless of a job performing frequency of the user having the predetermined relationship with the reservation user.
